(19) United States
(12) Patent Application Publication
(10) Pub. No.: US 2017/0063193 A1
(43) Pub. Date: Mar. 2, 2017

(54) REDUCTION BEARING AND ELECTRIC MOTOR

(71) Applicant: Shenzhen Volmen Precision Mechanical Technology Co., Ltd., Shenzhen (CN)

(72) Inventors: Miroslav VOLAK, Kosice (SK); Jozef BARNA, Presov (SK)

(73) Assignee: Shenzhen Volmen Precision Mechanical Technology Co., Ltd., Shenzhen (CN)

(21) Appl. No.: 15/245,830

(22) Filed: Aug. 24, 2016

(30) Foreign Application Priority Data
Aug. 25, 2015 (EP) 15182419.0
Aug. 8, 2016 (EP) 16183253.0

(51) Int. Cl. H02K 7/08; F16C 35/06; F16C 19/48; F16C 19/08; F16C 19/28

(52) U.S. Cl. CPC H02K 7/08; F16C 19/08; F16C 19/28; F16C 19/48; F16C 35/06; F16C 2380/26

(57) ABSTRACT

Reduction bearing having at least three concentric rings that include an inner ring with inner ring axial extension, a center ring with center ring axial extension and an outer ring with outer ring axial extension and at least two concentric rings of/with rolling elements including an inner concentric ring of/with rolling elements and an outer concentric ring of/with rolling elements. Inner ring and center ring are configured as bearing races for inner concentric ring of/with rolling elements and center ring and outer ring are configured as bearing races for the outer concentric ring of/with rolling elements. At least one reduction stage has a common reduction stage plane in which the inner ring extension, the center ring extension and the outer ring extension lie. The center ring extension is configured to transmit a wave-type reduction action between the inner ring extension and the outer ring extension.

### CROSS-REFERENCE TO RELATED APPLICATIONS

The present application claims priority under 35 U.S.C. §119(a) of European Patent Application No. EP 15 182 419.0 filed Aug. 25, 2015 and of European Patent Application No. EP 16 183 253.0 filed Aug. 8, 2016, the disclosures of which are expressly incorporated by reference herein in their entireties.

### BACKGROUND OF THE INVENTION

1. Field of the Invention

Embodiments relate to a reduction bearing having at least three concentric rings, the at least three concentric rings including an inner ring, a center ring and an outer ring, and at least two concentric rings of or with rolling elements. The inner ring and the center ring are configured as bearing races for an inner of the at least two concentric rings of or with rolling elements and the center ring and the outer ring are configured as bearing races for an outer of the at least two concentric rings of or with rolling elements. Embodiments further relate to an electric motor.

2. Discussion of Background Information

Radial bearings with concentric rings interposed with concentric rings of or with rolling elements are commonly used to take up radial forces while allowing rotational movement of rotating parts connected with the inner ring of the bearing around a common central axis of the concentric rings.

Gearboxes for rotational movements are known which are used to reduce a rotating speed of a rotating element being applied to an input of the gearbox into a slower rotation at an output of the gearbox. This is called a reduction action or reducing action within the present application.

Commonly known gearboxes themselves are not capable of or ill-suited to bearing radial forces and are therefore usually used in combination with external or additional radial bearings. Many technical applications require reducing action but are faced with the problem that commonly known gearboxes in combination with bearings are prohibitively large. One such field of technology is robotics, which has a particularly strong need for miniaturization combined with robust and precise rotary speed reduction. Another field of technology, in which the invention can be used, is automotive, especially electric cars and electric wheels.

### SUMMARY OF THE EMBODIMENTS

Accordingly, embodiments of the invention provide reliable and finely tunable small scale apparatus and method for reducing the rotating speed of the rotating element, which may additionally be particularly suited for use in the field of robotics or electric cars or electric wheels.

In embodiments, a reduction bearing has at least three concentric rings, the at least three concentric rings including an inner ring, a center ring and an outer ring, and at least two concentric rings of or with rolling elements. The inner ring and the center ring are configured as bearing races for an inner of the at least two concentric rings of or with rolling elements and the center ring and the outer ring are configured as bearing races for an outer of the at least two concentric rings of or with rolling elements. The reduction bearing has at least one reduction stage. Further, the inner ring, the center ring and the outer ring have, respectively, an inner ring extension, a center ring extension and an outer ring extension extending in an axial direction of the reduction bearing and lying in a common reduction stage plane. The center ring extension is configured to transmit a wave-type reduction action between the inner ring extension and the outer ring extension.

In advantageous embodiments, the inner ring extension is disk-shaped with or without a central opening and has an outer circumferential surface having one or more peaks and the outer ring extension has an inner circumferential surface having a toothing or grooves. Moreover, in advantageous embodiments, the inner ring extension is disk-shaped with or without a central opening and has an outer circumferential surface having a toothing or grooves and the outer ring extension has an inner circumferential surface having one or more peaks.

In advantageous embodiments, the inner ring has at least one bearing race. In particular, the inner ring extension has at least one profile bearing race or has at least one, preferably two, eccentric bearing race or races. In particular, the center ring has at least two bearing races in the bearing part and the center ring extension has at least one radial channel with one or more radially moving elements.

In contrast to known combinations of radial bearings and gearboxes without radial bearing capacity, embodiments of the reduction bearing are structurally radial bearings with added reduction functionality in the form of at least one reduction stage for a wave-type reduction action built into extensions of the at least three concentric rings of the bearing. This integration of the wave-type reduction stage into the bearing allows for a significant miniaturization with respect to earlier solutions. In the axial direction, the reduction bearing in embodiments may be a factor of two or more shorter than known combinations of bearings and gearboxes, even gearboxes of the wave-type or harmonic drive type.

This is made possible by using at least three concentric rings configured as bearing races for two concentric rings of or with rolling elements such that the three concentric rings are freely rotatable against each other while bearing radial forces, combined with the integration of a wave-type reduction stage into the extensions of the at least three concentric rings which is based on the known wave-type reduction principle, which is known to be implemented in such systems as the so-called harmonic drive or the so-called nested speed converting transmissions.

The operating principle of a wave-type reduction action is that a fast rotary motion of a innermost disk-shaped element having one or more peaks on its outer circumferential surface is translated into a slow rotary motion of an outer ring by way of an interposed circular structure which is radially flexible, or vice versa. This interposed circular structure does not rotate together with the innermost disk-shaped element, however, it assumes its shape as the innermost element rotates. The radially flexible structure has a number of teeth or of regularly spaced outwards projecting elements, whereas the outer ring has grooves or a toothing on its inner circumferential surface facing the toothing or the projecting elements of the flexible structure. The numbers of the teeth or grooves of the flexible structure and the outer ring do not match. Therefore, a rotation of the disk-shaped innermost element will induce a wave-like motion in the radially flexible structure, which may be of one piece or of a multitude of elements, and cause the teeth or projecting elements to slide into a succession of neighboring grooves in the outer ring toothing or groove structure with each passing peak of the innermost disk-shaped element, thereby transmitting the reduction action. The reduction action can also be transmitted from the outer ring having one or more peaks on an inner circumferential surface to an innermost disk-shaped element having a toothing or grooves on an outer circumferential surface.

The reduction stage may therefore comprise, for example, a radially flexible element together with a radially flexible roller bearing, similar to a harmonic drive, or radial channels and elements moving linearly within the radial channels, thus producing the radially flexible structure. This reduction stage fixes the relation of the motions between the three concentric rings in embodiments of the reduction bearing. Usually, one of the three rings will be affixed to a supporting structure. This is in most cases, but not necessarily, either the center ring or the outer ring. The input may be the inner ring and the output the center ring or the outer ring, whichever is not affixed to a supporting structure. The input and output may be reversed.

The reduction ratio between the rotating speed of the input and the rotating speed and direction of the output is determined by the number of peaks on the outer surface of the extension of the inner ring, the number of radial channels or teeth in the center ring and the number of grooves or teeth on the inside of the extension of the outer ring. The direction of the output is determined by whether the number of channels or teeth in or on the center ring extension is greater or smaller than the number of grooves in the extension of the outer ring.

By way of a non-limiting example, the inner ring extension may have two peaks at positions opposed to each other. Furthermore, there may be, e.g., 100 grooves in the outer ring extension and 98 channels with radially moving elements in the center ring extension, or teeth, respectively, the reduction stage will have a speed ratio of 50:1 from the inner ring input to the outer ring output, while the direction of rotation the same at output and input. If, under the same circumstances, the outer ring is affixed and the center ring is taken as output, the rotation direction of the center ring will be reversed with respect to the direction of rotation of the input. Furthermore, the reduction ratio will be slightly smaller.

In other advantageous embodiments, the center ring extension has structures defining radial channels containing radially moving elements contacting the inner surface of the outer ring extension and the outer circumferential surface of the inner ring extension. In particular, the number of grooves in the inner circumferential surface of the outer ring extension or the outer circumferential surface of the inner ring extension is greater or smaller than the number of radial channels of the center ring extension. In this way, in particular, the structures of the center ring defining radial channels are exchangeable or of one piece with the center ring. This constitutes an embodiment the above-mentioned multi-part radially flexible structure with the radially moving elements constituting the projecting elements which are able to follow and replicate the shape of the disk-shaped inner ring extensions with its peaks as it rotates inside the center ring. This solution is mechanically stable and cost-effective.

In the case of the structures of the center ring defining radial channels being exchangeable, repair of the reduction bearing is made easy. Also, the reduction bearing is then flexible in its configuration. On the other hand, center rings with structures which are one piece with the center ring provide added stability.

In an advantageous embodiment, the radial channels of the center ring extension are located in at least one row being arranged, at least substantially, parallel to the common reduction stage plane. To increase the capacity of the reduction bearing or gear box there are two or more rows of radial channels being arranged, at least substantially, parallel to the common reduction stage plane.

Preferably, a radial depth of the grooves, in particular in the inner circumferential surface of the outer ring extension, is equal to or more than a height in the radial direction of the peak or peaks, in particular on the outer circumferential surface of the inner ring extension. With this measure, it is effectively avoided that the reduction bearing may block its movement. The shape of the peaks, in particular on the outer circumferential surface of the inner ring extension, advantageously reflects the inverse of the shape of the grooves, in particular on the outer ring extension. With that, the linearly moving elements in the radial channels will have no or only very little play, thus reducing tear and wear of all components involved.

The radially moving elements preferably include one or more rows of sliding or rolling elements, in particular needles, balls or cylinders. This measure reduces wear and tear on the rolling elements, since the doubling or multiplying of the number of sliding or rolling elements reduces the stress on each one of them.

Advantageously, the circumferential surface having one or more peaks is replaced or formed by one or more eccentric circumferential or circular surfaces having bearing races. This embodiment leads to a reduction bearing with a very low friction. If two eccentric rings or two eccentric circumferential or circular surfaces are used, on which the rolling elements are carried, at the reduction stage the wave type reduction action is very sophisticated. The circumferential surfaces, which are advantageously of circular shape in cross section, are located at the reduction stage, preferably.

Advantageously, a radially flexible roller bearing is interposed between the outer circumferential surface of the inner ring extension and the center ring extension. The radially flexible roller bearing assumes the shape of the disk-shaped inner ring extension and transmits this shape to the radially moving elements. The outer bearing race of the radially flexible roller bearing does not rotate with respect to the center ring extension, so that there is low friction between the radially flexible roller bearing and the radially moving elements. Overall, friction is greatly reduced and efficiency enhanced.

In an alternative advantageous embodiment, the center ring extension is radially flexible and fitted around the inner ring extension by a flexible roller bearing so as to assume the outer shape of the inner ring extension while freely rotating around the inner ring extension. An outer circumferential surface of the radially flexible center ring extension has a toothing, and a number of teeth on the outer circumferential surface of the radially flexible center ring extension is smaller or greater than a number of teeth on the inner circumferential surface of the outer ring extension. This alternative embodiment reduces friction with respect to the above-mentioned embodiment because it does not involve the friction prone sliding motions between the linearly moving elements and the inner ring extension and the outer ring extension.

In a further preferred embodiment, the roller bearing is an integral part of the inner ring extension and/or the outer ring extension. Being an integral part of the inner ring extension and/or the outer ring extension, the roller bearing can be produced very precisely. Thus, the motion of the rotatable elements and also the rolling elements is very precise. In the state of the art roller bearings are normally extra rings, which are fitted or pressed in openings. This kind of manufacture leads to roller bearings, which are not very precisely mounted in the outer ring and/or the inner ring extensions.

In order to achieve a very high degree of space saving and miniaturization, the at least three concentric rings and the at least two concentric rings of or with rolling elements are preferably arranged in a bearing plane. The bearing plane has the added benefit of transmitting radial forces in the shortest possible pathway in one plane, i.e., without introducing cantilever forces.

Advantageously, there is an even number of peaks or, alternatively, an odd number with at least three peaks on the outer circumferential surface of the inner ring extension or on the inner circumferential surface of the outer ring extension. This feature helps eliminating radial forces in the reduction bearing since the radial force introduced into the bearing by each peak is countered by an opposing radial force from an opposing peak. The use of an odd number of peaks with a minimum of three peaks and equal spacing likewise balances any resulting radial forces by way of vector addition of the radial forces.

The number of teeth and/or grooves, in particular on the outer and central ring, should be greater than the number of peaks by a factor of 4 or more, preferably 10 or more, in order to ensure a smooth operation.

Advantageously, the inner ring and/or the center ring and/or the outer ring has or have through-holes for affixation to an external supporting structure. With this, it is possible to secure the inventive reduction bearing to an external supporting structure and choose the input and the output of the reduction bearing according to need.

In further advantageous embodiments, a separating element is located radially between first and further rolling elements. The rolling elements are then advantageously balls or of spherical shape. Furthermore, the separating element can have a circular shaped groove to be in contact with the rolling element. There can also be two circular shaped grooves for adjacent rolling elements or adjacent balls. The separating element can advantageously contain partly a surface or completely a surface of a friction reducing material, for example like polytetrafluoroethylene (such as Teflon® by Chemours). The separating element can be completely made of a friction reducing material. With this embodiment, friction is reduced. In this embodiment, a first rolling element may have contact with the grooves of one ring and a further rolling element will be in contact with the surface having one or more peaks on the opposite ring. If the rolling elements are shaped as balls or cylinders, the rotation of the rolling elements are decoupled by the separating element positioned between them, and each rolling element may in this embodiment rotate with its own speed driven by the movement of the respective surface of the reduction stage to which they have contact.

A further advantage of the reduction bearing of the present invention is that the inventive reduction bearing may have a large central opening, the size of which cannot be achieved in conventional gearboxes. For this purpose, the reduction bearing advantageously has an axial central opening with a diameter of up to 90%, in particular more than 35%, in particular more than 50% or 60% or 70%, of the outer diameter of the outer ring. The amount of the axial central opening depends in particular on the outer diameter of the outer ring and the ratio of the reduction bearing. Known gear boxes of similar type may have central openings, whose diameter, however, does not exceed 30% of the outer diameter of the device. The inventive feature of the large central opening is especially advantageous in the field of robotics, where in many applications it is necessary to feed through bundles of electric cables, for example in the joints of robot arms, which may not have enough space for feeding through in conventional gearboxes, or in the fields of electric cars or electric wheels.

In an advantageous further development, the reduction bearing has two or more reduction stages configured such that at least one first reduction stage is drivingly connected to at least one second reduction stage, wherein the reduction stages are axially aligned with each other and/or positioned concentrically to each other. The inventive reduction bearing has the added benefit that it may comprise two or more reduction stages, each provided with a concentric three-ring bearing arrangement which may be coupled in parallel or sequentially. With this combination, very high reduction ratios may be achieved. For example, a combination of two reduction bearing stages with each a reduction factor of 100:1 will result in a reduction factor of 10.000:1 with very few parts to achieve this reduction factor.

The combination may be advantageously achieved in a so-called serial configuration or a so-called parallel configuration. In the serial configuration, a first reduction stage and a second reduction stage are axially aligned, wherein one of the inner ring, the center ring and the outer ring of the first reduction stage is connected with one of the inner ring, the center ring and the outer ring of the second reduction stage, in particular by a spline connection. Even with the two stages axially aligned with each other, the total axial size of the reduction bearing is still less than that of conventional one-stage gearboxes. The serial configuration also lends itself for three or more reduction stages in serial axial relationship. Each stage may have its own output so that the multi-stage reduction bearing may beneficially provide multiple reduction ratios to be used alternatively or simultaneously.

In the alternative parallel configuration, which may beneficially also be combined with a serial combination to achieve three or more reduction stages, a first reduction stage and a second reduction stage are positioned concentrically to each other, wherein the second reduction stage is arranged concentrically around the first reduction stage, wherein an outer ring of the first reduction stage is of one piece with an inner ring of the second reduction stage.

This configuration is in effect a concentric five-ring arrangement with four interposed rings of or with rolling elements constituting the radial bearing, wherein the third of the five concentric rings is part of both reduction stages at the same time. The second, third and fourth ring of the bearing have inner and outer bearing races, the innermost ring has an outer bearing race, the outermost ring has an inner bearing race.

In this case, advantageously one of the inner ring and the central ring of the first reduction stage and one of the central ring and the outer ring of the second reduction stage are affixed or affixable to a supporting structure. The ring common to the first stage and the second stage should not be affixed, since that would decouple the two reduction stages.

The reduction bearing in the parallel configuration preferably has two outputs at different reduction stages and different reduction values. This increases the versatility of the reduction bearing with two or more stages, wherein the outputs at different reduction values may be used alternatively or simultaneously.

Embodiments are directed to an electric motor, which has at least one reduction bearing according to the above-described invention integrated with or into the electric motor. A casing of the electric motor forms a supporting structure for the reduction bearing and a rotor of the electric motor is drivingly connected or integral with an input ring of the reduction bearing. Such an electric motor with integrated reduction bearing may be advantageously used in a robotics application and other applications, where the small size of the combination of the electric motor and the integrated inventive reduction bearing is particularly useful.

Further characteristics of the invention will become apparent from the description of the embodiments according to the invention together with the claims and the included drawings. Embodiments according to the invention can fulfill individual characteristics or a combination of several characteristics.

Embodiments are directed to a reduction bearing. The reduction bearing includes at least three concentric rings including an inner ring with an inner ring axial extension, a center ring with a center ring axial extension and an outer ring with an outer ring axial extension, and at least two concentric rings of or with rolling elements including an inner concentric ring of or with rolling elements and an outer concentric ring of or with rolling elements. The inner ring and the center ring are configured as bearing races for the inner concentric ring of or with rolling elements and the center ring and the outer ring are configured as bearing races for the outer concentric ring of or with rolling elements. At least one reduction stage has a common reduction stage plane in which the inner ring extension, the center ring extension and the outer ring extension lie. The center ring extension is configured to transmit a wave-type reduction action between the inner ring extension and the outer ring extension.

According to embodiments, the inner ring extension may be disk-shaped either with or without a central axial opening. Further, the reduction bearing can include one of: the inner ring extension has an outer circumferential surface with one or more peaks and the outer ring extension has an inner circumferential surface with grooves; or the inner ring extension has an outer circumferential surface with grooves and the outer ring extension has an inner circumferential surface with one or more peaks. Further, in a bearing part, the inner ring can include at least one bearing race surface and the center ring comprises at least two bearing race surfaces, the inner ring extension may include one of: at least one profiled bearing race or at least one eccentric bearing race, and the center ring extension may include at least one radial channel with one or more radially moving elements. The at least one eccentric bearing race can include at least two eccentric bearing races. Moreover, the center ring extension may have structures defining radial channels containing radially moving elements configured to contact the inner circumferential surface of the outer ring extension and the outer circumferential surface of the inner ring extension. The radial channels can be located in at least one row arranged at least substantially parallel to the common reduction stage plane, and the radially moving elements may include at least one row of sliding or rolling elements. The structures of the center ring defining the radial channels can be one of removably replaceable or of one piece with the center ring. Still further, the at least one row of sliding or rolling elements can include needles, balls or cylinders. Further still, a number of the grooves in the one of the inner circumferential surface of the outer ring extension or in the one of the outer circumferential surface of the inner ring extension may be different from a number of the radial channels of the center ring extension. A radial depth of the grooves in the inner circumferential surface of the outer ring extension can be at least equal to a height in the radial direction of the peak or peaks on the outer circumferential surface of the inner ring extension, and a shape of the peak or peaks on the outer circumferential surface of the inner ring extension can be an inverse of a shape of the grooves on the outer ring extension. Also, the one of the inner circumferential surface with one or more peaks and the outer circumferential surface with one or more peaks may be replaceable or formed by at least two eccentric circumferential surfaces having bearing race surfaces.

In accordance with embodiments, the reduction bearing may further include a radially flexible roller bearing interposed between the outer circumferential surface of the inner ring extension and the center ring extension. The radially flexible roller bearing can be an integral part of at least one of the inner ring extension and the center ring extension.

According to still other embodiments, the at least three concentric rings and the at least two concentric rings of or with rolling elements may be arranged in a bearing plane. Further, one of: an even number of peaks on the one of the outer circumferential surface of the inner ring extension or the inner circumferential surface of the outer ring extension, or an odd number with at least three peaks on the one of the outer circumferential surface of the inner ring extension or the inner circumferential surface of the outer ring extension.

In embodiments, the reduction bearing may further include a separating element located radially between two rolling elements.

Moreover, at least one of the inner ring, the center ring and the outer ring can have through-holes for affixation to an external supporting structure. Further, the reduction bearing can have two outputs at different reduction stages and different reduction values.

According to other embodiments, the reduction bearing may further include an axial central opening with a diameter that is one of: 90% of the outer diameter of the outer ring; more than 35% of the outer diameter of the outer ring; more than 50% of the outer diameter of the outer ring; more than 60% of the outer diameter of the outer ring; or more than 70% of the outer diameter of the outer ring.

In accordance with still yet other embodiments of the present invention, the at least one reduction stage can include at least two reduction stages configured so that at least one first reduction stage is drivingly connected to at least one second reduction stage. The first and second reduction stages may be at least one of: axially aligned with each other, and positioned concentrically to each other. When axially aligned with each other, one of the inner ring, the center ring and the outer ring of the first reduction stage can be connected with one of the inner ring, the center ring and the outer ring of the second reduction stage. Further, when positioned concentrically to each other, the second reduction stage can be arranged concentrically around the first reduction stage, the outer ring of the first reduction stage may be of one piece with the inner ring of the second reduction stage, and one of the inner ring and the central ring of the first reduction stage and one of the central ring and the outer ring of the second reduction stage can be affixed or affixable to a supporting structure.

Embodiments are directed to an electric motor with or in which an above-described embodiment of the at least one reduction bearing is integrated. The electric motor includes a casing of the electric motor configured as a supporting structure for the reduction bearing; and a rotor of the electric motor is one of drivingly connected to or integral with an input ring of the at least one reduction bearing.

Other exemplary embodiments and advantages of the present invention may be ascertained by reviewing the present disclosure and the accompanying drawing.

### BRIEF DESCRIPTION OF THE DRAWINGS

The invention is described below, without restricting the general intent of the invention, based on exemplary embodiments, wherein reference is made expressly to the drawings with regard to the disclosure of all details according to the invention that are not explained in greater detail in the text, in which like reference numerals represent similar parts throughout the several views of the drawings, and wherein:

FIG. 1 schematically illustrates a cross sectional representation of an inventive restriction bearing,

FIG. 2 schematically illustrates a perspective representation of the reduction bearing of FIG. 1,

FIG. 3a) to c) schematically illustrates a representation of an inner ring of the inventive reduction bearing,

FIG. 3d) to f) schematically illustrates a representation of an inner ring of an embodiment of the inventive reduction bearing, wherein two eccentric rings are used at the reduction stage,

FIG. 4a) to c) schematically illustrates a representation of a center ring of the inventive reduction bearing,

FIG. 4d) schematically illustrates a representation of a center ring of the inventive reduction bearing in a further embodiment,

FIG. 5a) to c) schematically illustrates a representation of an outer ring of the inventive reduction bearing,

FIG. 6a) to d) schematically illustrates a representation of a reduction stage of a reduction bearing according to the invention,

FIG. 7a) to e schematically illustrates a representation of another embodiment of an inventive reduction bearing,

FIG. 7f) to h) schematically illustrates a representation of a reduction stage of a reduction bearing according to an embodiment of the invention with two eccentric rings at the reduction stage,

FIG. 8a) to d) schematically illustrates a representation of a two stage inventive reduction bearing in a parallel configuration,

FIG. 9a) to d) schematically illustrates a representation of a two stage reduction bearing of the invention in serial configuration,

FIG. 10a), b) schematically illustrates a representation of an electric motor according to the invention, and

FIG. 10c) schematically illustrates a representation of a further embodiment of an electric motor according to the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the drawings, the same or similar types of elements or respectively corresponding parts are provided with the same reference numbers in order to prevent the item from needing to be reintroduced.

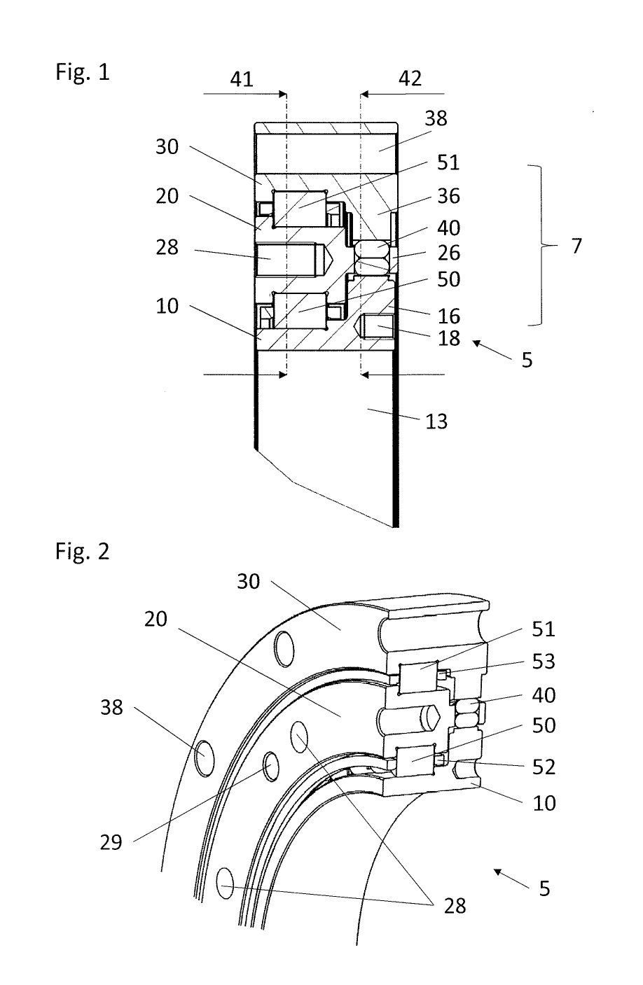

FIG. 1 shows schematically a cross section through an exemplary embodiment of a reduction bearing 5 according to the invention. The reduction bearing 5 comprises three concentric rings, namely an inner ring 10, a center ring 20 and an outer ring 30. In the left part, a bearing plane 41 is marked which contains parts of the three concentric rings 10, 20 and 30 and two concentric rings of or with rolling elements 50, 51 placed between, respectively, the inner ring 10 and the center ring 20, and the center ring 20 and the outer ring 30. The elements in the bearing plane 41 therefore constitute a radial rolling bearing with three rotatable rings 10, 20, 30. The rolling elements 50, 51 are cylinders by way of example, but also any other kind of or with rolling elements used in bearings may be used, such as balls, needles, etc.

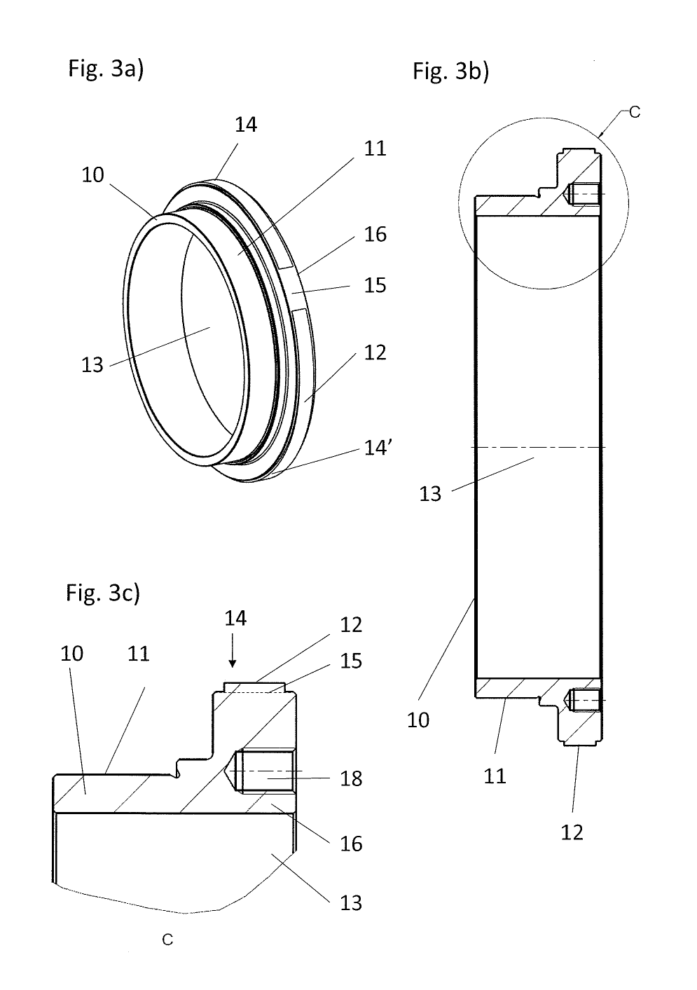

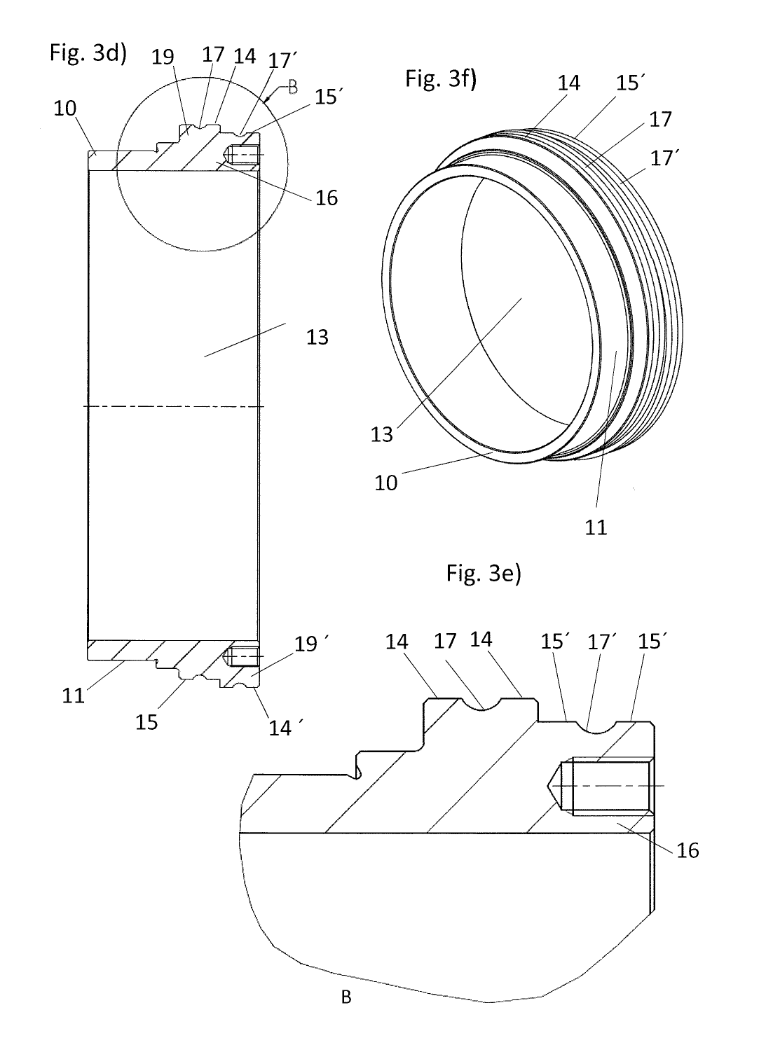

The three rings 10, 20, 30 have extensions 16, 26, 36, respectively, which extend axially from the rings 10, 20, 30 and lie in a common reduction stage plane 42. They constitute a reduction stage 7 consisting of a disc-shaped inner ring extension 16 which at its outer circumference is in contact with radially moving elements 40 caged inside radially oriented channels inside the center ring extension 26, as well as the outer ring extension 36, the inner circumferential surface of which contacts the radially moving elements 40. The structure of the circumferential surfaces 12 of the inner ring extension 16 and the outer ring extension 36 will be discussed in connection with FIGS. 3, 5 and 6.

FIG. 2 shows a schematic perspective view of the reduction bearing 5 according to FIG. 1. It can be seen that the rolling elements 50, 51 of the bearing part are caged in rolling element cages 52, 53. It is also shown that the reduction bearing 5 has a central opening 13 which constitutes a significant portion of its total diameter. In addition, three holes for affixation and connection to input and output devices are shown in the center ring 20 and the outer ring 30, namely in input connection 18 in the inner ring extension 16, an output connection 28 in the center ring 20 and a through hole 38 in the outer ring 30 for affixation to a supporting structure.

A detailed view of the inner ring 10 is shown in FIGS. 3a), 3b), 3c), 3d), 3e) and 3f). FIG. 3a) shows a perspective view of inner ring 10 having a large central opening 13 and a bearing part configured as a circular bearing race 11. This bearing race 11 supports the inner circle of or with rolling elements 50 shown in FIGS. 1 and 2. In the axial direction, the disc-shaped inner ring extension 16 is shown which has a non-circular outer circumferential surface 12. As depicted in FIG. 3a), the portion next to the reference numeral 16 is configured as a valley 15 having a minimum diameter, whereas above and below this portion, the circumferential surface 12 shows two shallow peaks 14, 14′, providing the total circumferential surface 12 with an elliptical shape. Another valley is located opposite to the valley 15. The surface 12 may also have three or more peaks.

FIG. 3b) shows a more detailed cross-sectional view of the inner ring 10, the part C of which is shown in a magnified version in FIG. 3c). The circumferential surface 12 has a central part slightly elevated over its boundaries, marking a peak 14. This elevated central part will vanish at the position of a valley 15 halfway between two peaks 14, 14′. The surface at a valley position is indicated with a dashed line in FIG. 3c). This variation in height causes the linearly moving elements 40 depicted in FIGS. 1 and 2 to perform a radial movement in the respective radial channels in the center ring extension 26.

FIGS. 3d), 3e) and 3f) show a schematic representation of the inner ring 10. FIG. 3d) is a cross section view, FIG. 3e) is an enlarged view of part B of FIG. 3d), and FIG. 3f) is a perspective view of the inner ring 10. There is shown a preferred embodiment of the invention. At the reduction stage, two eccentric rings 19, 19′ of circular shape are used instead of one disk with two peaks. The circumferential surface of the two eccentric rings 19, 19′ is formed by two rings radially shifted relative to each other and also to the common axis of the inner ring 10. By this measure, two peaks 14, 14′ and two valleys 15, 15′ are created on the extension 16 of the inner ring 10. The valley 15 is opposite to the valley 15′ and the peak 14 is opposite to the peak 14′. The bearing races 17, 17′ of the two rings 19, 19′ are profiled and are integral part of the inner ring extension 16. With this embodiment, it is preferred to use balls as rolling elements. Having the bearing races 17, 17′ being integrated in the inner ring extension, the bearing races 17, 17′ are very precisely formed.

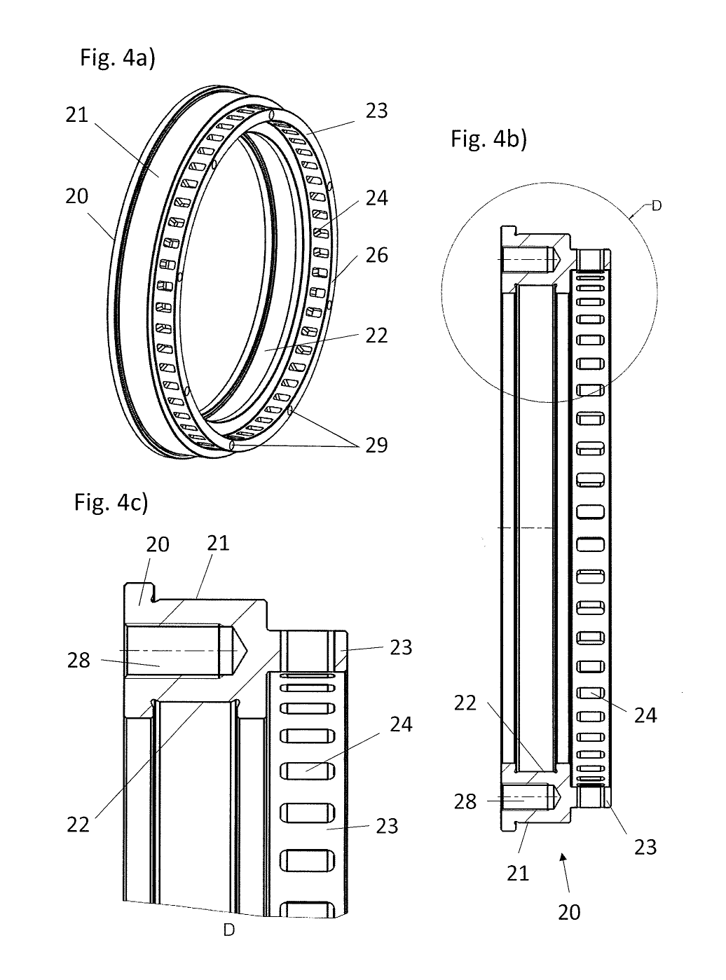

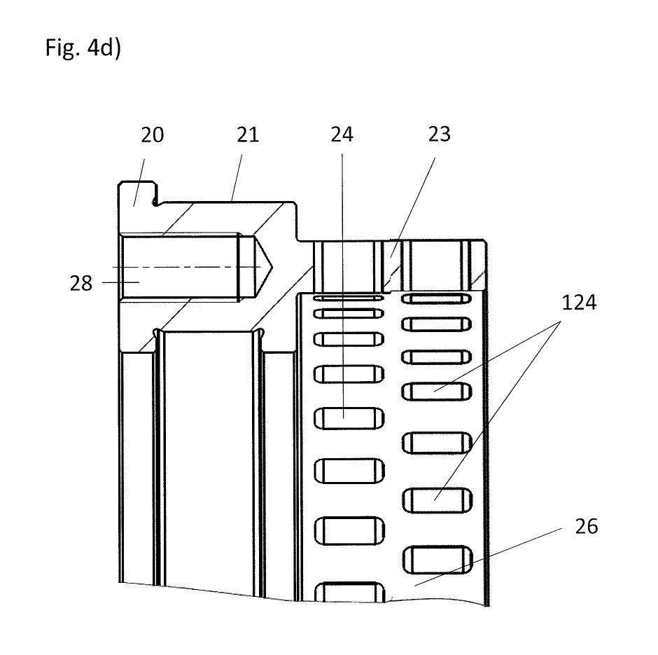

In FIGS. 4a), 4b), 4c), the center ring 20 is depicted schematically in more detail. As shown in the perspective view in FIG. 4a), center ring 20 includes a bearing part with a circular bearing race 21 on the outside and a circular bearing race 22 on the inside, the bearing races 21, 22, respectively, being in contact with the rolling elements 50 and 51 of FIGS. 1 and 2.

The axial center ring extension 26 comprises a cage with radial channels 24 for guiding the linear movement of the radially moving elements 40 depicted in FIGS. 1 and 2. The center ring extension 26 itself is of cylindrical shape. Its inner diameter is slightly larger than the outer diameter of the inner ring extension 16 at peak diameter 14, 14′.

In FIG. 4d) it is shown that the center ring extension 26 is further elongated and additional radial channels 124 which can also be grooves are added. Due to this embodiment, the carrying capacity of the reduction bearing is enhanced. The radial channels 24 and 124 are arranged in two rows.

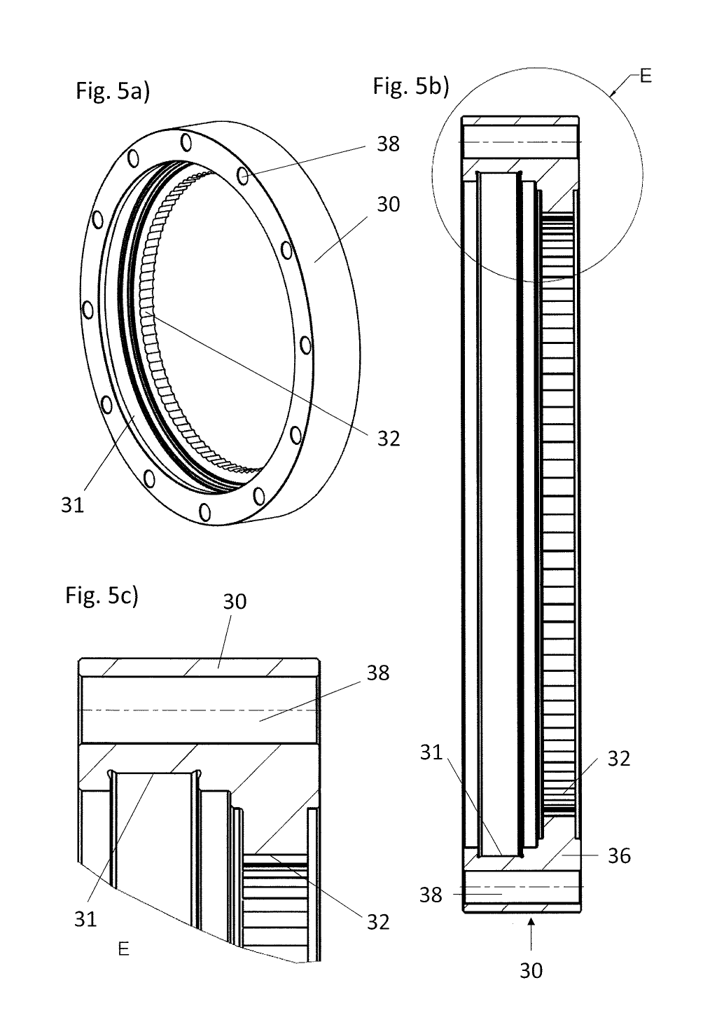

FIGS. 5a), 5b), 5c) show a schematic representation of the outer ring 30 of the inventive reduction bearing 5 of FIGS. 1 and 2. The outer ring 30 has an inner circumferential bearing surface configured as a bearing race 31 contacting the rolling elements 51 of the outer ring of or with rolling elements shown in FIGS. 1 and 2. In the axial direction, the outer ring extension 36 has an inner circumferential surface whose diameter is smaller than the diameter of the bearing race 31 and has grooves 32, the depth of which roughly matches the difference between peak height 14, 14′ and valley height 15, 15′ of the peaks on the inner ring extension 16. The variation in the radial height of the grooves 32 follows the variation of the circumferential surface 12 of the inner ring extension 10, shortened in circumferential direction by the reduction ratio of the reduction stage.

The number of grooves 32 is different from the number of radial channels 24, 124 in the center ring extension 26 by a small number, usually by 2, especially in case of 2 peaks.

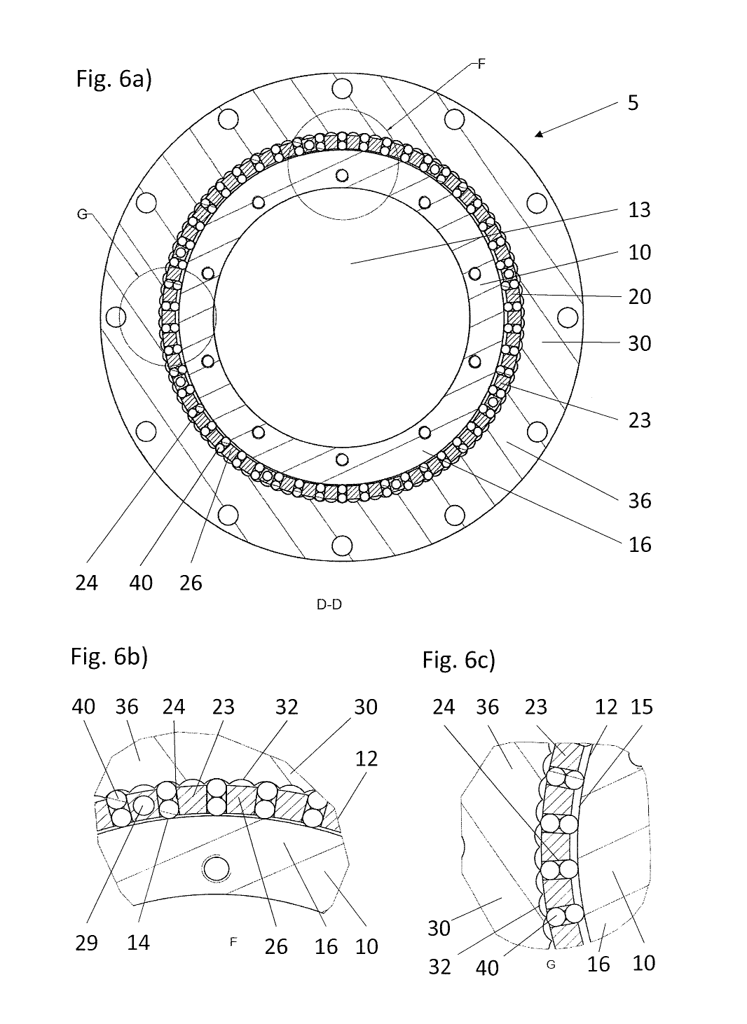

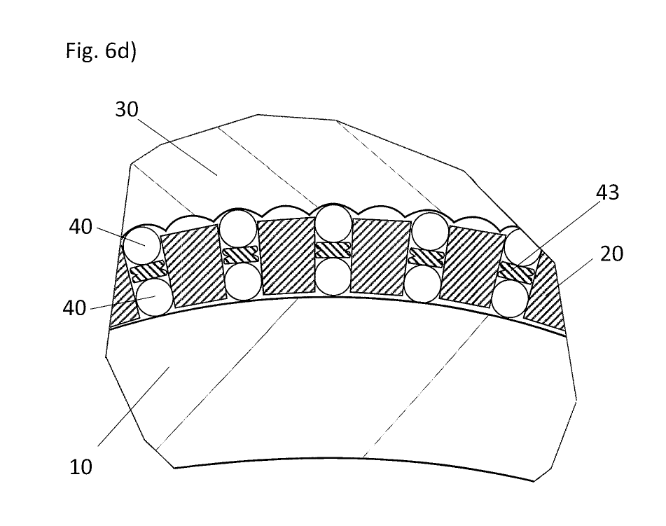

FIGS. 6a), 6b) and 6c) show a further exemplary embodiment of a single-stage reduction bearing 5 according to the invention with inner ring 10, center ring 20 and outer ring 30, in a cross section through the reduction stage plane 42. The center ring extension 26, which is built as a separator 23, is of circular shape. The outer circumferential surface 12 of the inner ring extension 16 matches the inner diameter of the separator 23 in the top and in the bottom positions while leaving a narrow gap to the inner surface of the separator 23 in the left and right positions shown in FIG. 6a). This implies that the outer circumferential surface 12 of the inner ring separator 16 is not round, but exhibits two peaks, shown in the top and bottom positions. The inner circumferential surface of the outer ring extension 36 in contrast exhibits a multitude of grooves 32, which are slightly broader than the radially moving elements 40 located inside radial channels 24 of the separator 23.

To increase the carrying capacity of the reduction bearing with respect to keep minimal diameter of reduction bearing there can be placed more rolling elements 40 in two or more rows in a cage with radial grooves 24. See for example FIG. 6b).

To further enhance the carrying capacity of the reduction bearing, there can be skipped every second groove in the separator and herewith to enlarge thickness of wall separators 23 while the reduction ratio will be kept. Through the enlarged wall separators 23 can be guided openings 29 in the axial direction over the center ring 20. For example a screw can be screwed into a guided opening 29.

As can be seen in FIG. 4d), a further enhancement of carrying capacity of the reduction bearing can be achieved by elongation of center ring extension 26 and adding additional grooves 124 and rolling elements, shifted by one tooth in radial direction.

Rotating the inner ring 10 will result in a collective revolving wave-type motion of the radially moving elements 40 in the separator 23. Since the number of grooves is greater by 2 than the number of radial channels 24, a rotation of the inner ring 10 as input of the inventive reduction bearing 5 will cause the radially moving elements 40 to be pushed into the respective grooves 32 of the outer ring extension 36 from off-center into the center of the grooves 32 at the passing of a peak 14, 14′, thereby causing the center ring 20 and the outer ring 30 to rotate relative to each other by the amount of one groove 32 with each passing of a peak 14, 14′ on the outer circumferential surface 12 of the inner ring extension 16, that is, for each half revolution of the inner ring 10.

FIGS. 6b) and 6c) show magnified excerpts F and G from FIG. 6a), respectively, namely at peak height 14 and valley height 15. At peak height 14, as shown in FIG. 6b), the centrally depicted radially moving elements 40 are pushed into the opposing grooves 32 to the maximum extent. At valley height 15, as shown in FIG. 6c), the linearly moving elements 40 are opposed by an edge between two adjacent grooves 32. Further rotation of the inner ring 10 will cause the separator 23 to rotate slightly in the clockwise or anti-clockwise direction, depending on the direction of rotation of the inner ring 10, so that with the arrival of the next peak 14 on the outer circumferential surface 12 of the inner ring extension 16, the linearly moving elements 40 will be pushed into the next adjacent groove 32.

As can be seen in FIG. 1, this is achieved in a very compact design which at the same time assures a reduction action and radial bearing capacity.

It is furthermore advantageous, as shown in FIG. 6d), to separate the moving elements 40 radially by a separating element 43, which is located between a first and further, in this case, two, moving elements 40 and can be moved radially together with the moving elements 40. This separating element 43 preferably has low-friction surfaces or is made wholly out of a low-friction material and decouples the rotation of the rolling elements 40 from each other, thus reducing friction and wear of the rolling elements 40.

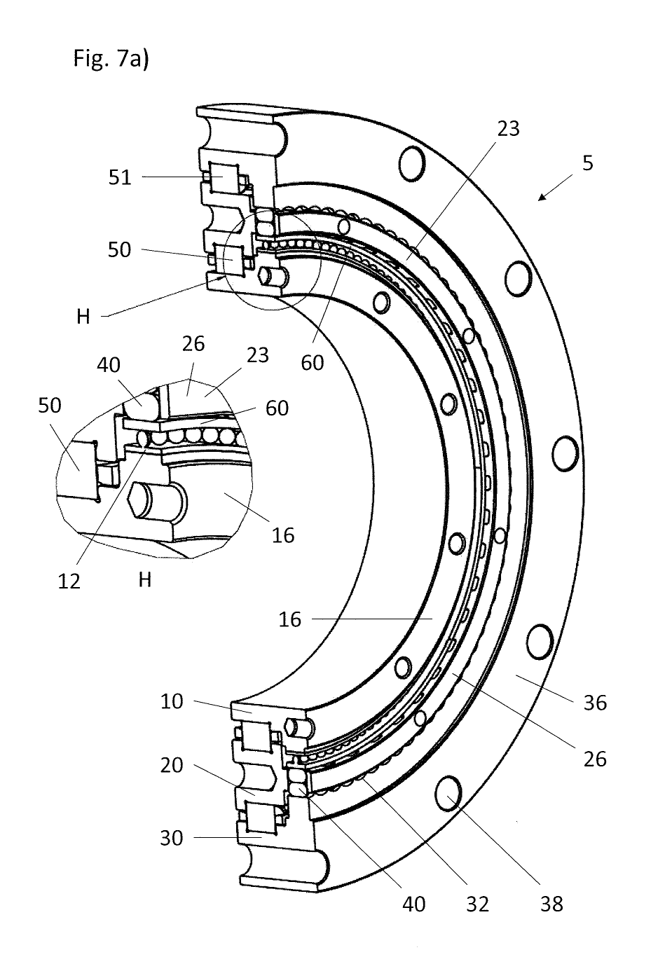

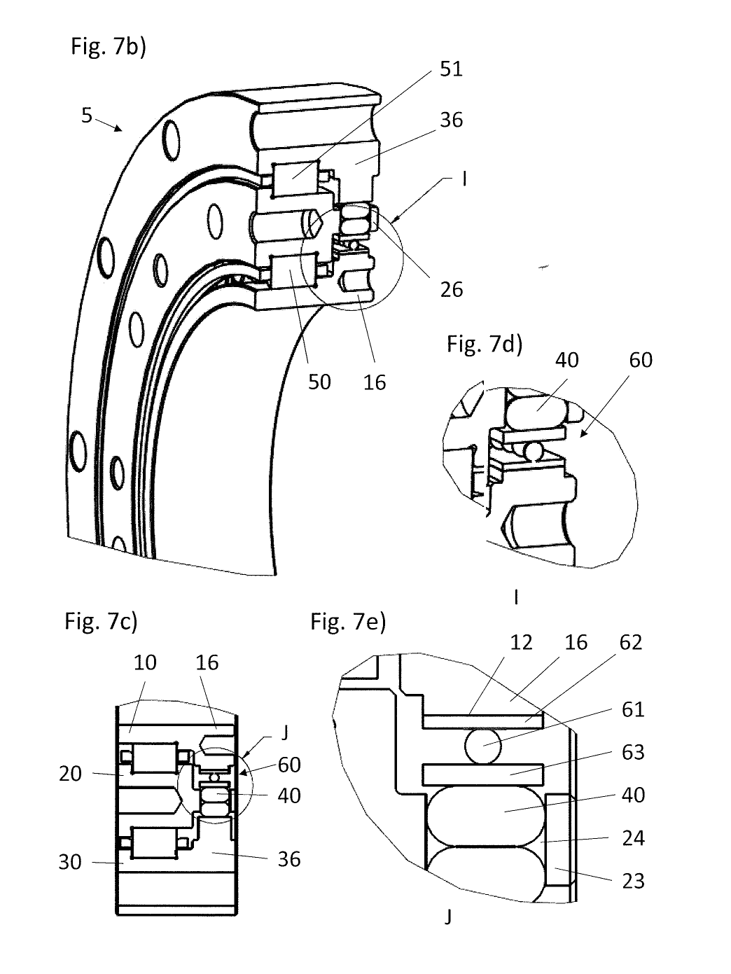

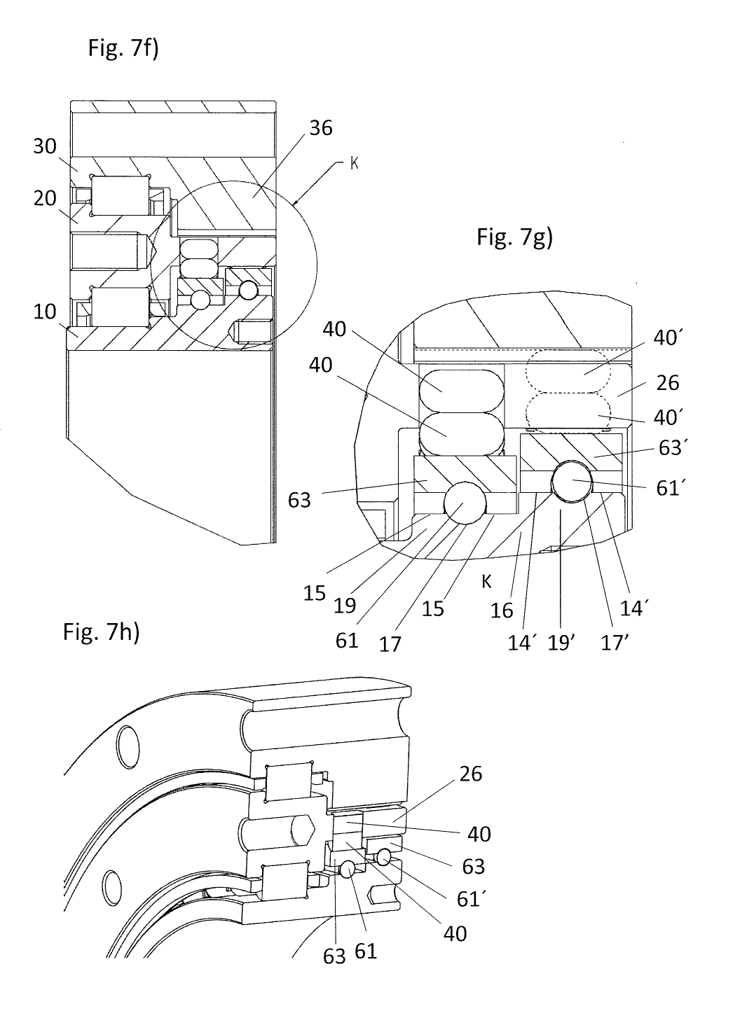

FIGS. 7a) to 7e) show a further embodiment of a reduction bearing 5 according to the invention. The structure of the reduction bearing 5 shown in a half-open perspective in FIG. 7a) is almost identical to the one shown in FIGS. 1 and 2, with the exception that a radially flexible roller bearing 60 is interposed between the outer circumferential surface 12 of the inner ring extension 16 and the separator 23 with the radially moving elements 40. As can best be seen in FIG. 7e), the radially flexible roller bearing 60 comprises rolling elements 61 positioned between an inner bearing race 62 and an outer bearing race 63. Further details are shown in cross section and perspectively in FIGS. 7b), 7c) and 7d). The use of a radially flexible roller bearing 60 reduces friction and enhances the longevity and efficiency of the reduction bearing 5. The radially flexible roller bearing 60 itself does not need to withstand large radial forces, which are absorbed by the rolling elements 50, 51 in the bearing plane 41 instead.

In a preferred embodiment shown in FIGS. 7f), 7g) and 7h), the bearing ring 62 can be replaced by a profiled extension of the inner ring 12, which can act as a bearing race. FIG. 7f) shows a schematic cross sectional view of a reduction bearing according to the invention, in case two eccentric rings 19 and 19′ are used as an extension of the inner ring 10 as shown in FIGS. 3d), 3e) and 3f) and as an extension of the center ring of FIG. 4d).

FIG. 7g) is an enhanced view of the section K of FIG. 7f) in a schematic view. FIG. 7h) shows the embodiment in a schematic three-dimensional view. It is furthermore shown that bearing races 17, 17′ are integrated into the rings 19 and 19′ or a part of the surface of the rings 19 and 19′. Furthermore, rolling elements 60, 61 and 40, 40′ as well as rings 63 and 63′, which can be used from standard bearings, are inserted. The shafts of the two eccentric rings 19, 19′ are eccentric. There is no flexible roller bearing or roller racing in this embodiment. This embodiment is more easily to be produced with high precision than the embodiment, in which an ellipsoid is used with two peaks and two valleys instead of two eccentric rings 19, 19′. In case of an ellipsoid, one roller racing or one bearing ring is advantageously flexible.

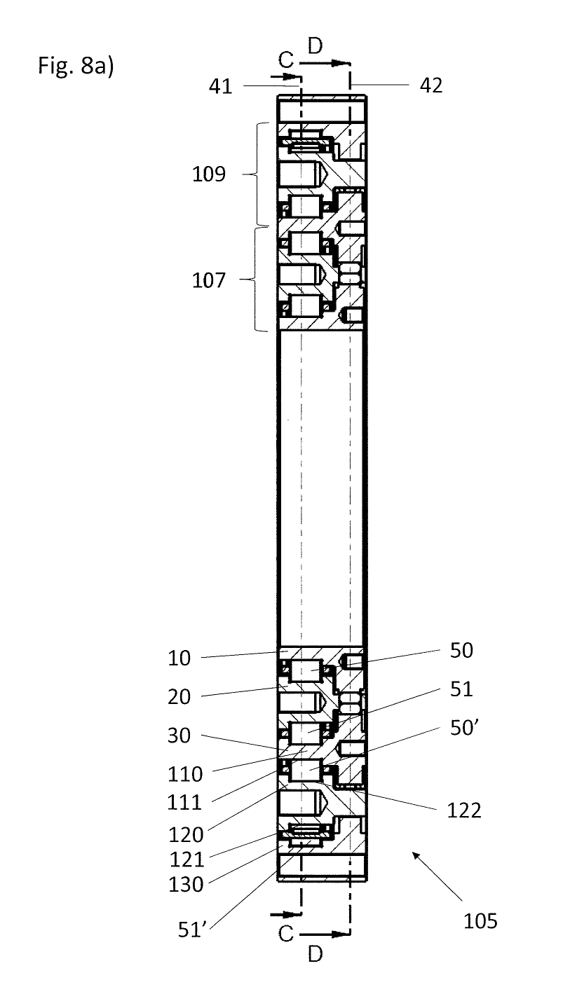

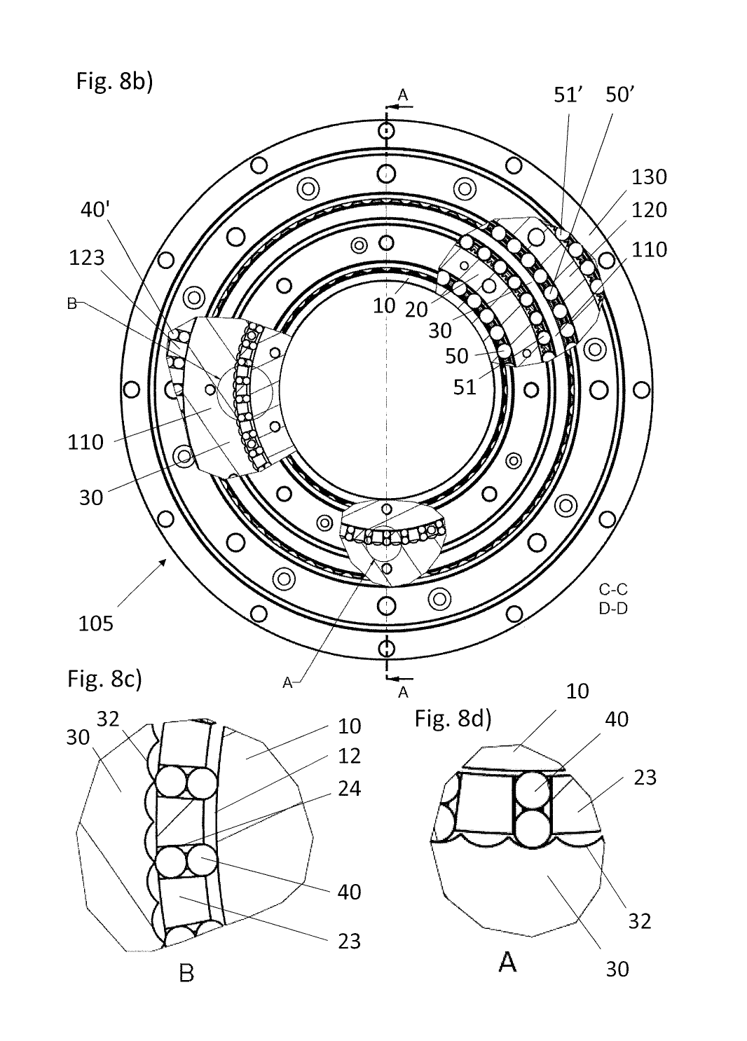

FIGS. 8a) to 8d) show a further exemplary embodiment of an inventive reduction bearing 105 having two reduction stages 107, 109, arranged concentrically inside each other. A first reduction stage 107 shown in FIG. 8a) comprises inner ring 10, center ring 20 and outer ring 30. The second reduction stage 109 comprises inner ring 110, center ring 120 and outer ring 130. Outer ring 30 of the first reduction stage 107 is the same as the inner ring 110 of the second reduction stage 109. This middle ring 30/110 of the parallel, that is, concentric two stage configuration shown in FIG. 8 has two bearing races in the bearing plane 41, namely one on the inside and one on the outside. Accordingly, the parallel configuration two-stage reduction bearing 105 of FIG. 8 has four concentric circles of the rolling elements 50, 51 in the bearing plane.

Each of the five rings 10, 20, 30/110, 120, 130 has its own axial extensions which are in principle structured in the same way as the ones depicted in the previous figures.

FIG. 8b) shows the two-stage reduction bearing 105 from one side with three areas opened up to show different parts of the interior of the reduction bearing 105. The opened area in the upper right allows a view into the bearing plane 41 with the rings 10, 20, 30/110, 120, 130 and the rolling elements 50, 51, 50′, 51′ constituting the radial bearing functionality of the reduction bearing 105.

The lowermost opening with area A is magnified in FIG. 8d). It is clearly visible that the innermost and first stage 107 is configured in the same way as the single stage embodiment of, for example, FIG. 6. FIG. 8c) shows a magnification of area B. FIGS. 8c) and 8d) correspond to the views in figures in FIGS. 6b) and 6c), respectively.

In the interior view containing the area B, a glimpse can be had inside the reduction stage plane 42 of the second reduction stage 109, showing that, whereas the radially moving elements 40 in the second reduction stage 109 are bigger than those in the first reduction stage 107 shown, for example, in the area B in FIG. 8b). The principle of action is the same in the second reduction stage 109 as in the first reduction stage 107.

With this parallel concentric configuration, it is possible to combine two reduction stages into a reduction action having a very large reduction factor calculated as the product of the reduction factor of the first reduction stage 107 and of the reduction factor of the second reduction stage 109. Reduction factors of 10.000 and more can be thus achieved.

Since radial forces are observed by the bearing parts in the bearing plane 41 of the inventive reduction bearing 5, 105, the reduction action incorporated in the structures in the reduction stage plane 42 are largely free of radial forces, so that blocking because of radial forces is effectively eliminated.

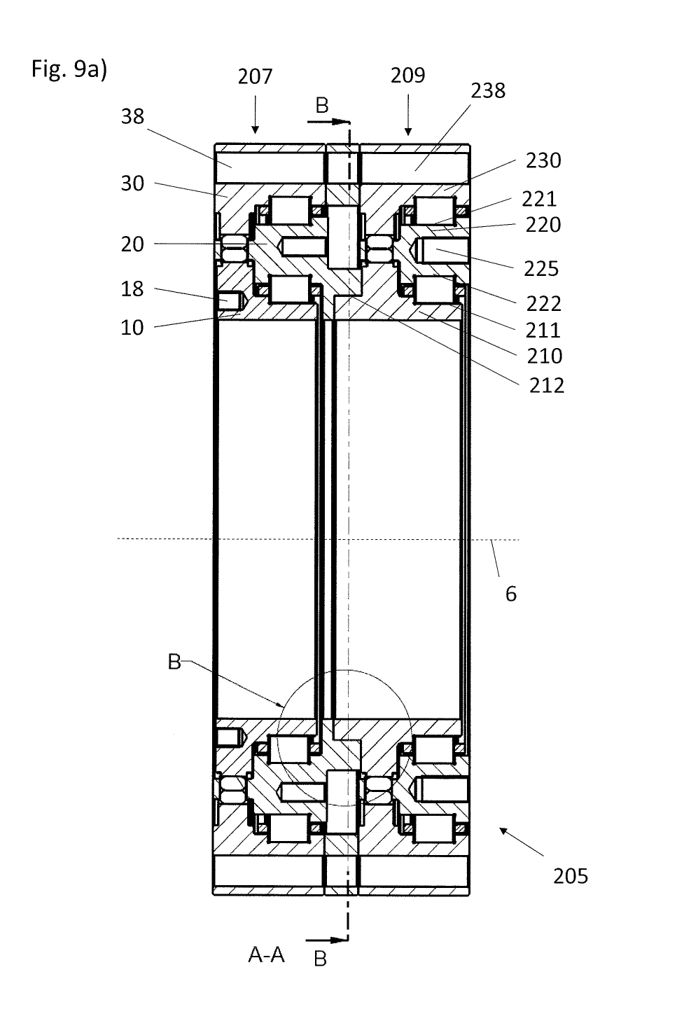

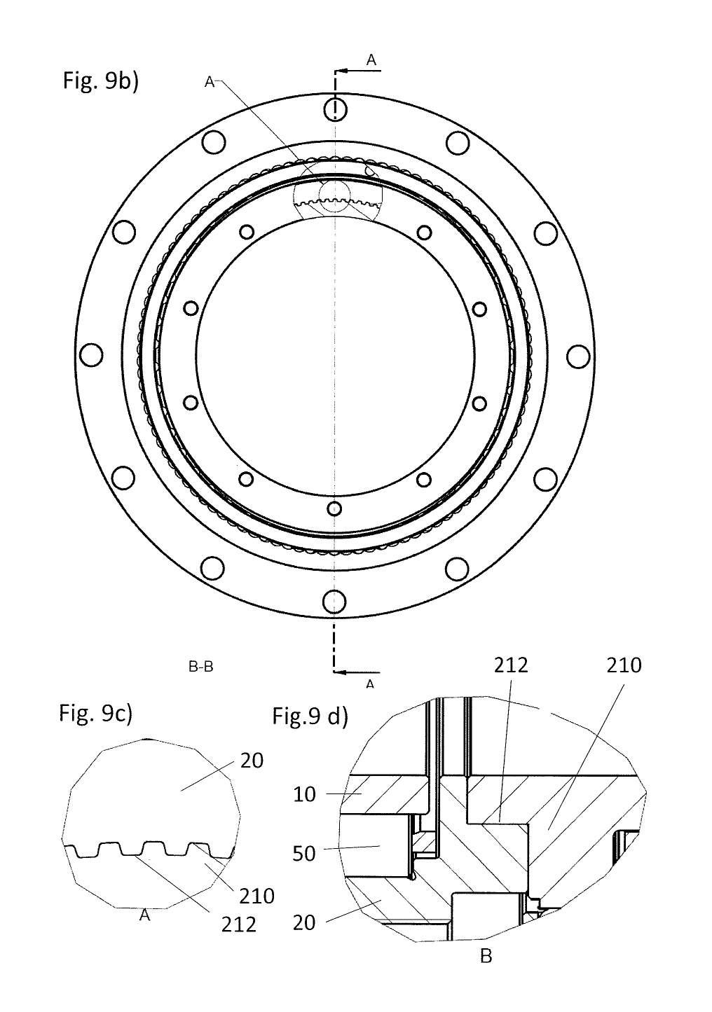

FIGS. 9a) to 9d) show a further exemplary embodiment of an inventive reduction bearing 205. The reduction bearing 205 is a two-stage in a serial configuration, that is, the two stages 207, 209 are aligned axially along central axis 6 of the reduction bearing 205, which again has a basically circular shape, as shown in FIG. 9b). Each of the two reduction stages 207 and 209 comprise three concentric rings 10, 20, 30 and 210, 220, 230, respectively, which are mainly structured as shown in the previous figures.

In the configuration shown in FIG. 9a), the inner ring 10 of the first reduction stage 207 is driven by an input connection 18. The outer ring 30 may be affixed to a supporting structure (not shown) by through hole 38. Rotation of the inner ring 10 will cause a slower rotation of the center ring 20 of the first reduction stage 207.

The center ring 20 of the first reduction stage 207 is connected via a driving connection 212, which is built as a spline connection, to the inner ring 210 of the second reduction stage 209. The spline connection, which is shown in an expanded view in FIG. 9d), has a circumferential toothing shown in an expanded view in FIG. 9c).

The center ring 220 has an output connection 225. The outer ring 230 likewise has a through hole 238 for connection to a supporting structure. A rotation at the input 18 of the inner ring 10 of the first reduction stage 207 therefore leads to a very slow rotation of the output 225 in the center ring 220 of the second reduction stage 209.

The reduction stages 207, 209 may be built in a modular manner such that reduction stages may be chosen with desired reduction ratios and combined in the way shown in FIG. 9a) to arrive at freely selectable high reduction ratios.

As in the case of the reduction bearing 105 in the parallel configuration of FIG. 8d), the rotating motion of the two reduction stages 207 and 209 may be used separately and in parallel, adding to the versatility of the invention reduction bearing 205. The two stages 207, 209 may be oriented in the same way, as in the present example shown in FIG. 9a), or may have back-to-back bearing planes or reduction planes, depending on the desired configuration.

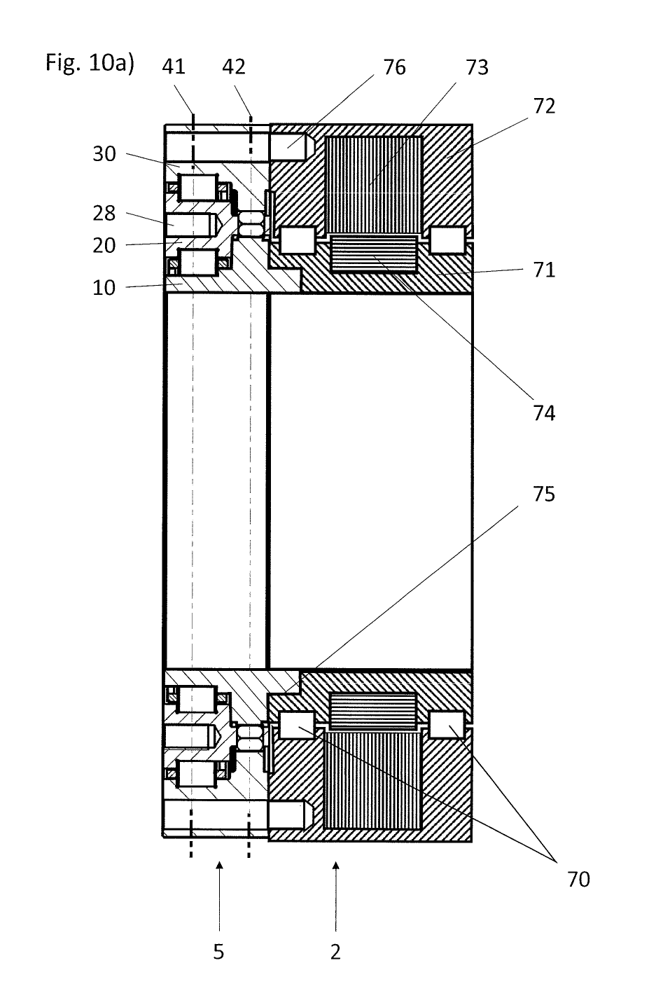

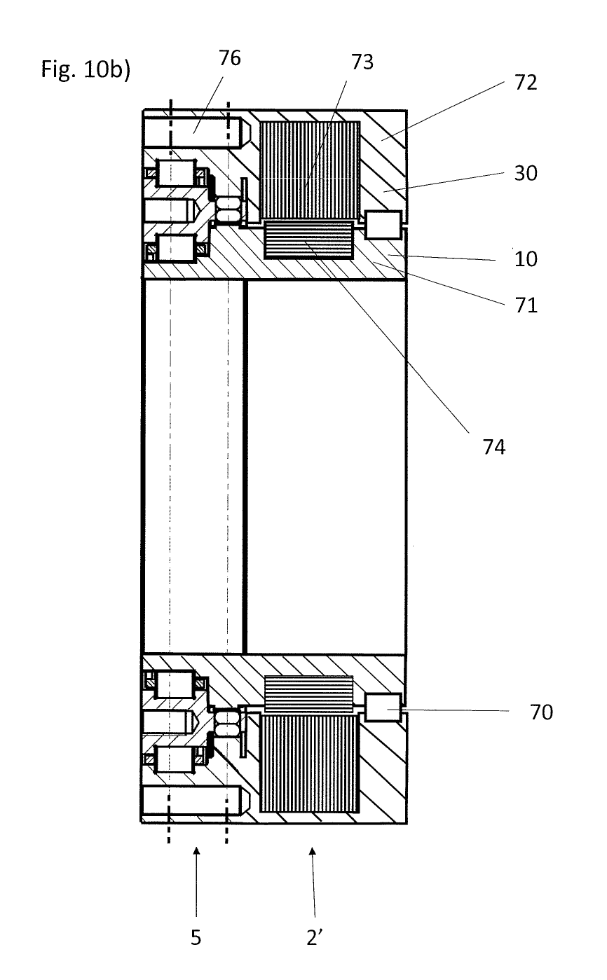

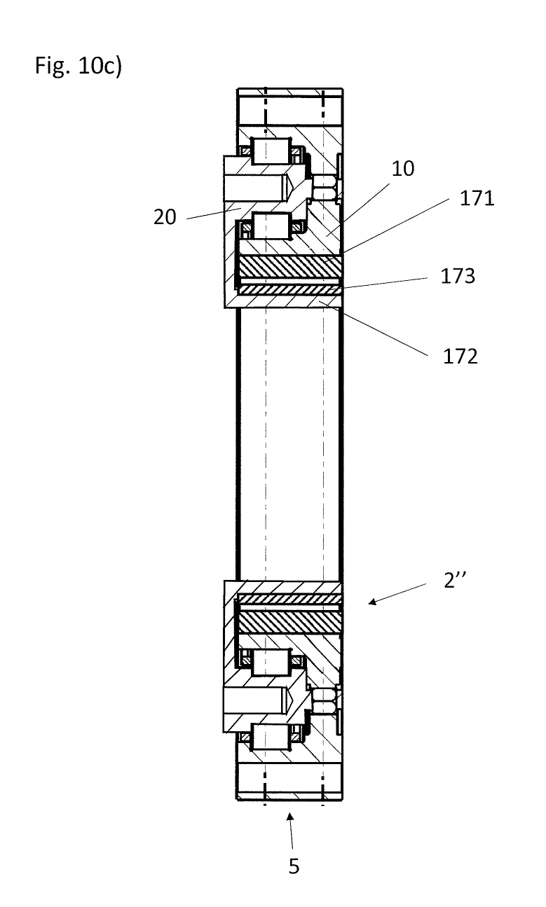

Two exemplary embodiments of electric motors 2, 2′ according to the invention are shown schematically in FIGS. 10a), 10b).

The electric motor 2 shown in FIG. 10a) comprises a casing 72 housing a stator 73 arranged around a rotor 71 with rotor coils 74, wherein the rotor 71 is supported against the casing 72 by motor bearings 70 at each side of the coils 74 in the axial direction. A reduction bearing 5 according to the invention is affixed to the casing 72 through a casing connection 76. The rotor 71 is drivingly connected to the inner ring 10 of the reduction bearing 5 by, e.g., a spline connection 75. The center ring 20 has an output connection 28 rotating with a reduced speed with respect to the rotor 71. Here, the reduction bearing 5 is integrated with the electric motor 2 by connections 75 and 76.

The alternative embodiment of an electric motor 2′ shown in FIG. 10b) differs from the one shown in FIG. 10a) in that the reduction bearing 5 is fully integrated. The casing 72 is integral with the outer ring 30, the rotor 71 is integral with the inner ring 10 of the reduction bearing 5. There is only one motor bearing 70, since the radial forces on the other side are born by the reduction bearing, in particular the bearing parts arranged in the bearing plane 41.

In a further embodiment depicted in FIG. 10c), an electric motor 2″ can be arranged to perform with a higher integration. In particular, a thin-Gap type electric motor 2″ is shown in FIG. 10c). The reduction bearing 5 is fully integrated. The casing 172 is integral with the center ring 20. The rotor 171 is integral with the inner ring 10 of the reduction bearing 5. The stator 173 has a small gap to the rotor 171. An electric motor 2″ can thus be used which can be built very small in size.

Both exemplary embodiments constitute very efficient and compact designs of electric motors 2″, which are of great use in robotics and other technical fields requiring compact reduced electric motor action.

All named characteristics, including those taken from the drawings alone, and individual characteristics, which are disclosed in combination with other characteristics, are considered alone and in combination as important to the invention. Embodiments according to the invention can be fulfilled through individual characteristics or a combination of several characteristics. Features which are combined with the wording “in particular” or “especially” are to be treated as preferred embodiments.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCES

2, 2′, 2″ electric motor
5 reduction bearing
6 central axis
7 reduction stage
10 inner ring
11 bearing race
12 circumferential surface
13 central opening
14, 14′ peak
15, 15′ valley
16 inner ring extension
17, 17′ bearing race
18 input connection
19, 19′ eccentric circumferential surface
20 center ring
21 bearing race
22 bearing race
23 separator
24 radial channels
26 center ring extension
28 output connection
29 opening
30 outer ring
31 bearing race
32 grooves
36 outer ring extension
38 through hole
40, 40′ radially moving elements
41 bearing plane
42 reduction stage plane
43 separating element
50, 50′ rolling elements
51, 51′ rolling elements
52, 53 rolling element cage
60 radially flexible roller bearing
61, 61′ rolling element
62 inner bearing race
63, 63′ outer bearing race
70 motor bearings
71 rotor
72 casing
73 stator
74 rotor coils
75 spline connection
76 casing connection
105 reduction bearing
107 first reduction stage
109 second reduction stage
110 inner ring
111 bearing race
120 center ring
121 bearing race
122 bearing race
123 separator
124 additional radial channel
130 outer ring
171 rotor
172 casing
173 stator
205 reduction bearing
207 first reduction stage
209 second reduction stage
210 inner ring
211 bearing race
212 driving connection
220 center ring
221 bearing race
222 bearing race
225 output connection
230 outer ring

What is claimed:

1. A reduction bearing comprising:
at least three concentric rings including an inner ring with an inner ring axial extension, a center ring with a center ring axial extension and an outer ring with an outer ring axial extension;
at least two concentric rings of or with rolling elements including an inner concentric ring of or with rolling elements and an outer concentric ring of or with rolling elements, wherein the inner ring and the center ring are configured as bearing races for the inner concentric ring of or with rolling elements and the center ring and the outer ring are configured as bearing races for the outer concentric ring of or with rolling elements; and
at least one reduction stage having a common reduction stage plane in which the inner ring extension, the center ring extension and the outer ring extension lie,
wherein the center ring extension is configured to transmit a wave-type reduction action between the inner ring extension and the outer ring extension.

2. The reduction bearing according to claim 1, wherein the inner ring extension is disk-shaped either with or without a central axial opening, and
wherein one of:
the inner ring extension has an outer circumferential surface with one or more peaks and the outer ring extension has an inner circumferential surface with grooves; or
the inner ring extension has an outer circumferential surface with grooves and the outer ring extension has an inner circumferential surface with one or more peaks.

3. The reduction bearing according to claim 2, wherein, in a bearing part, the inner ring comprises at least one bearing race surface and the center ring comprises at least two bearing race surfaces,
wherein the inner ring extension comprises one of: at least one profiled bearing race or at least one eccentric bearing race, and
wherein the center ring extension comprises at least one radial channel with one or more radially moving elements.

4. The reduction bearing according to claim 3, wherein the at least one eccentric bearing race comprises at least two eccentric bearing races.

5. The reduction bearing according to claim 2, wherein the center ring extension has structures defining radial channels containing radially moving elements configured to contact the inner circumferential surface of the outer ring extension and the outer circumferential surface of the inner ring extension,
wherein the radial channels are located in at least one row arranged at least substantially parallel to the common reduction stage plane, and
wherein the radially moving elements comprise at least one row of sliding or rolling elements.

6. The reduction bearing according to claim 5, wherein the structures of the center ring defining the radial channels are one of removably replaceable or of one piece with the center ring.

7. The reduction bearing according to claim 5, wherein the at least one row of sliding or rolling elements comprises needles, balls or cylinders.

8. The reduction bearing according to claim 2, wherein a number of the grooves in the one of the inner circumferential surface of the outer ring extension or in the one of the outer circumferential surface of the inner ring extension is different from a number of the radial channels of the center ring extension.

9. The reduction bearing according to claim 2, wherein a radial depth of the grooves in the inner circumferential surface of the outer ring extension is at least equal to a height in the radial direction of the peak or peaks on the outer circumferential surface of the inner ring extension, and
wherein a shape of the peak or peaks on the outer circumferential surface of the inner ring extension is an inverse of a shape of the grooves on the outer ring extension.

10. The reduction bearing according to claim 2, wherein the one of the inner circumferential surface with one or more peaks and the outer circumferential surface with one or more peaks is replaceable or formed by at least two eccentric circumferential surfaces having bearing race surfaces.

11. The reduction bearing according to claim 1, further comprising a radially flexible roller bearing interposed between the outer circumferential surface of the inner ring extension and the center ring extension.

12. The reduction bearing according to claim 11, wherein the radially flexible roller bearing is an integral part of at least one of the inner ring extension and the center ring extension.

13. The reduction bearing according to claim 1, wherein the at least three concentric rings and the at least two concentric rings of or with rolling elements are arranged in a bearing plane, and
wherein one of:
an even number of peaks on the one of the outer circumferential surface of the inner ring extension or the inner circumferential surface of the outer ring extension, or
an odd number with at least three peaks on the one of the outer circumferential surface of the inner ring extension or the inner circumferential surface of the outer ring extension.

14. The reduction bearing according to claim 1, further comprising a separating element located radially between two rolling elements.

15. The reduction bearing according to claim 1, wherein at least one of the inner ring, the center ring and the outer ring has through-holes for affixation to an external supporting structure.

16. The reduction bearing according to claim 15, wherein the reduction bearing has two outputs at different reduction stages and different reduction values.

17. The reduction bearing according to claim 1, further comprising an axial central opening with a diameter that is one of:
90% of the outer diameter of the outer ring;
more than 35% of the outer diameter of the outer ring;
more than 50% of the outer diameter of the outer ring;
more than 60% of the outer diameter of the outer ring; or
more than 70% of the outer diameter of the outer ring.

18. The reduction bearing according to claim 1, wherein the at least one reduction stage comprises at least two reduction stages configured so that at least one first reduction stage is drivingly connected to at least one second reduction stage,
wherein the first and second reduction stages are at least one of:
axially aligned with each other, and
positioned concentrically to each other, and
wherein, when axially aligned with each other, one of the inner ring, the center ring and the outer ring of the first reduction stage is connected with one of the inner ring, the center ring and the outer ring of the second reduction stage.

19. The reduction bearing according to claim 18, wherein, when positioned concentrically to each other, the second reduction stage is arranged concentrically around the first reduction stage,
wherein the outer ring of the first reduction stage is of one piece with the inner ring of the second reduction stage, and
wherein one of the inner ring and the central ring of the first reduction stage and one of the central ring and the outer ring of the second reduction stage are affixed or affixable to a supporting structure.

20. An electric motor with or in which the at least one reduction bearing according to claim 1 is integrated, comprising:
a casing of the electric motor configured as a supporting structure for the reduction bearing; and
a rotor of the electric motor is one of drivingly connected to or integral with an input ring of the at least one reduction bearing.
